(19) United States
(12) Patent Application Publication
(10) Pub. No.: US 2022/0009336 A1
(43) Pub. Date: Jan. 13, 2022

(54) SPECIALTY TRACTOR

(71) Applicant: CNH Industrial America LLC, New Holland, PA (US)

(72) Inventors: Michelantonio Forte, Modena (IT); Alberto Borghi, Carpineti (IT)

(73) Assignee: CNH Industrial America LLC, New Holland, PA (US)

(21) Appl. No.: 17/296,177

(22) PCT Filed: Nov. 19, 2019
(86) PCT No.: PCT/EP2019/081805

§ 371 Date: May 21, 2021

(30) Foreign Application Priority Data
Nov. 21, 2018 (IT) 102018000010486

(51) Int. Cl. B60K 6/442; B60K 17/28; B60K 6/387; B60K 6/40; B60K 6/547; B60K 6/24; B60W 30/188; B60W 20/20; B60W 10/02; B60W 10/06; B60W 10/08

(52) U.S. Cl. CPC B60K 6/442; B60K 17/28; B60K 6/387; B60K 6/40; B60K 6/547; B60K 2006/4808; B60W 30/1888; B60W 20/20; B60W 10/02; B60W 10/06; B60W 10/08; B60K 6/24

(57) ABSTRACT

Specialty tractor includes a diesel engine coupled with a powertrain including a clutch and a manual shift transmission having an output shaft that is designed to transmits power to the wheels of the tractor. An electric motor includes an output shaft connected through a power transmission to the output shaft of the manual shift transmission. The specialty tractor includes an electronic unit configured to perform at least a first operating mode and a second operating mode. In the first operating mode the clutch is opened and the manual transmission does not receive any torque from the diesel engine, and the electric motor transmits torque to the wheels the tractor. In the second operating mode the clutch is closed and the manual transmission receives torque from the diesel engine so that the engine-torque is transmitted to the wheels of the tractor that moves at a speed higher than the speed limit.

### CROSS REFERENCE TO RELATED APPLICATIONS

This application is a U.S. National Stage filing of International Application Ser. No. PCT/EP2019/0081805 entitled “SPECIALTY TRACTOR,” filed Nov. 19, 2019, which claims priority to Italian Application Serial No. 102018000010486, filed Nov. 21, 2018, each of which is incorporated by reference herein in its entirety for all purposes.

### TECHNICAL FIELD

The present invention relates to a specialty tractor.

### BACKGROUND OF THE INVENTION

Specialty tractors are low power tractors (usually around 100 hp), small and narrow, whose working weight rarely exceeds 3 tons. Their main usage is to support specialized operations for orchard and vineyard agriculture: therefore they must cope with hard environments such as narrow spaces of maneuver, difficult grounds such as hills. A specialty tractor has a diesel engine provided with a powertrain wherein a manual transmission transmits the torque generated by the engine to the wheels of the tractor. Specialty tractors are normally used with implements (the working mission of the specialty tractor is to spend the 80% of its working time using the PTO and power hydraulics) that are powered by the Power Take Off (PTO) available on the tractor. In several applications, the users need to have the angular speed of the PTO independent (i.e. decoupled) from the tractor ground speed. Normally this decoupling function is obtained by using a CVT transmission installed in the PTO box; however, specialty tractors have constraints in term of available space and CVT transmission cannot be installed in the PTO box as a rule.

The aim of the present invention is to provide with a low cost and a with a simple solution a specialty tractor whose PTO angular speed is independent from the ground speed of the tractor. The present invention is also focused in obtaining the above aim without modifying the original mechanical structure of the mechanical transmission that, as a rule, is quite simple, robust and cheap. In other words, the architecture of the powertrain of an already existing specialty tractor may be updated and upgraded to an Hybrid Electric Diesel configuration in order to offer a wide series of advantages to the customers.

### SUMMARY OF THE INVENTION

The above is obtained by the present invention that relates to a specialty tractor provided with a diesel engine coupled with a powertrain including a clutch and a manual shift transmission having an output shaft that is designed to transmits power to the wheels of the tractor, the diesel engine is also coupled with a PTO box having a PTO shaft that is used to power implements that can be towed/carried by the tractor, characterized by comprising an electric generator receiving torque directly from the diesel engine and providing electric power to an energy accumulator such as a battery or a supercapacitor; power electronics is designed to draw up electrical power from the energy accumulator to supply an electric motor whose output shaft may be connected/disconnected though a power transmission to said output shaft; an electronic unit for controlling power electronics and said power transmission, the electronic unit being configured to perform at least:

a first operating mode wherein the clutch is opened and the manual transmission does not receive any torque from the diesel engine; the electric motor supplied by the energy of the accumulator transmits torque to the wheels of the tractor that moves on the ground with a speed lower than a speed limit; the diesel engine is controlled so that it has a set Rpm that produces a desired angular speed of the PTO shaft making the angular speed of the PTO shaft independent from the speed of the tractor on the ground; and

a second operating mode wherein the clutch is closed and the manual transmission receives torque from the diesel engine so that the engine-torque is transmitted to the wheels of the tractor that moves at a speed higher than the speed limit; during the second operating mode the electric motor is unpowered.

### BRIEF DESCRIPTION OF THE DRAWINGS

The invention shall be described in the accompanied drawings that represent a not-limiting example of the invention wherein;

FIG. 1 represents schematically the transmission of a specialty tractor operating according to the present invention; and

FIGS. 2, 3 and 4 shown a specialty tractor operating according to an embodiment of the present invention.

### DETAILED DESCRIPTION OF THE INVENTION

Numeral 1 indicates a specialty tractor, i.e. a tractor having a power around 100 hp, whose working weight rarely exceed 3 tons. The main usage of specialty tractor 1 is to support specialized operations for orchard and vineyard agriculture.

Specialty tractor is provided with a diesel engine 2 coupled with a conventional powertrain 3 to provide torque to the wheels 4 of the tractor 1. Powertrain 3 includes a mechanical clutch 5 (of a known kind, for instance an hydraulic or electric actuated clutch) having an input shaft 5-a connected with an output shaft 2-a of the diesel engine 2 and an output shaft 5-b connected with an input shaft 6-a of a manual shift transmission 6 having an output shaft 6-b that transmits power to the rear axle of the tractor to power rear wheels 4. Gear ratios are manual shifted in manual transmission 6.

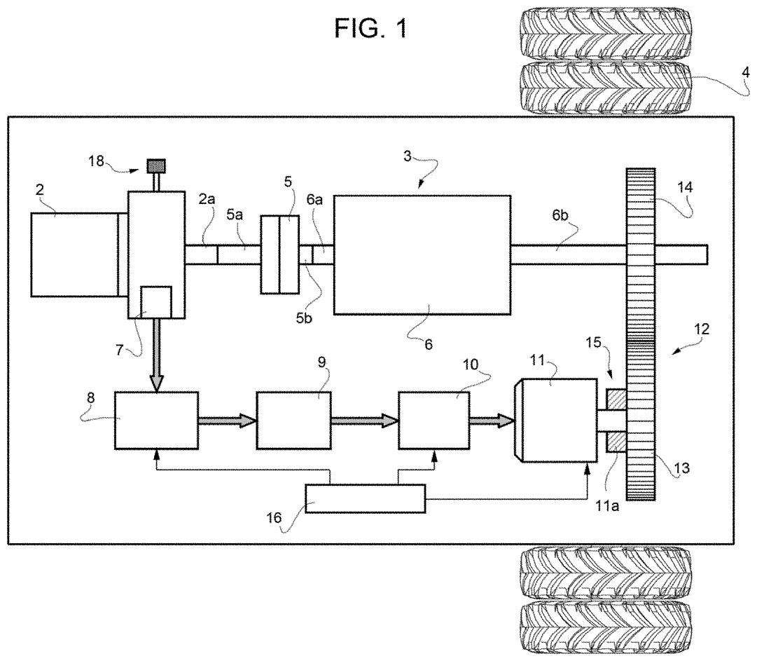

According to the present invention, an electric generator 7 receives torque from the output shaft 2-a of the diesel engine 2 and provides electric power to a first power electronics 8 that stores the electric power in an energy accumulator 9 such as a battery, a battery pack or a supercapacitor. A second power electronics 10 is designed to draw up electrical power from energy accumulator 9 to supply an electric motor 11 whose output shaft 11-a may be connected though a power transmission 12 to the output shaft 6-b. The transmission 12 (of know kind) establishes specific gear ratio to the output shaft 6-a and has been schematized in FIG. 1 by means of a couple of gears 13, 14 mounted respectively on shafts 11-a and 6-a and mating one with the other. Of course, the structure of the transmission 12 may be quite different from those represented. A clutch 15 (in the example a dog clutch) is provided along the power transmission to selectively connect/disconnect the output shaft 11-a of the electric motor with the output shaft 6-a of the manual transmission.

Typically the electric motor 11 has a power preferably not exceeding 25 kW and is supplied by the second power electronics 10 with a voltage not exceeding 70 V (48 Volts most preferably) so that the complete installation of energy accumulator 9 and electric motor 11 is a low voltage installation type with a big simplification in terms of safety and packaging.

An electronic unit 16 controls first and second power electronics 8 and 10 and the actuators (not shown) that controls the clutch 15.

The output shaft of the diesel engine 2 is also coupled with a PTO box having a PTO shaft 18 that is used to power an implement that may be towed/carried by the tractor 1.

The electronic unit 16 is designed to detect the ground speed of the tractor in order to perform at least the following operating modes:

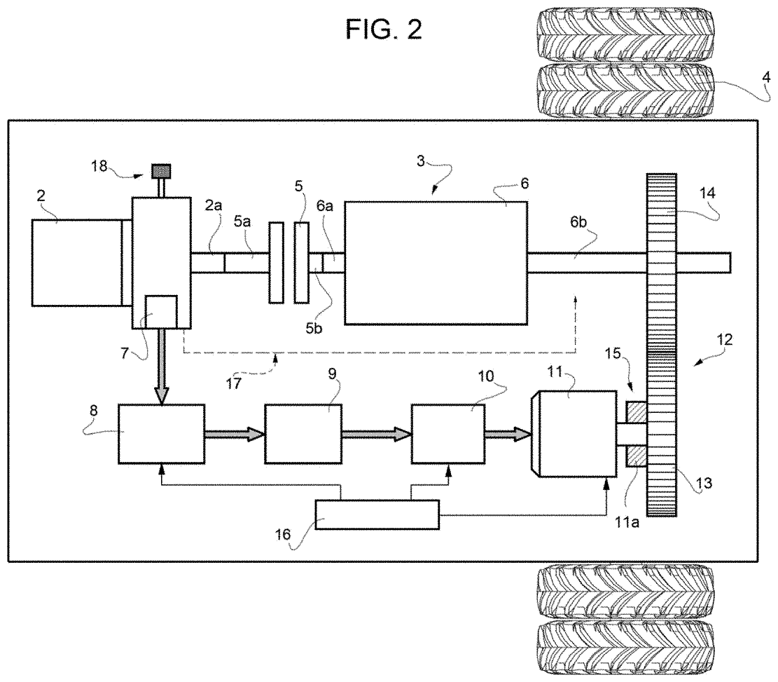

A first operating mode (FIG. 2) wherein the clutch 5 is opened and the manual transmission 6 does not receive any torque from the diesel engine 2. The clutch 15 is closed and the electric motor 11 powered by the energy accumulator 9 transmits torque to the wheels 4 of the tractor that moves at low speed with the behavior of a CVT. Low speed means that the speed is lower than a speed limit; most preferably tractor ground speed may be comprised in the following speed interval 4, 5-18 km/h. Power is thus supplied from the diesel engine 2 to the electric motor 11 through an electrical path 17 and energy accumulator 9 acts as a power reserve. During the first operating mode, the diesel engine 2 is controlled so that it has a set Rpm that produces a desired angular speed of the PTO shaft 17. The angular speed of the PTO shaft 18 is independent (i.e. decoupled) from the ground speed of the tractor 1;

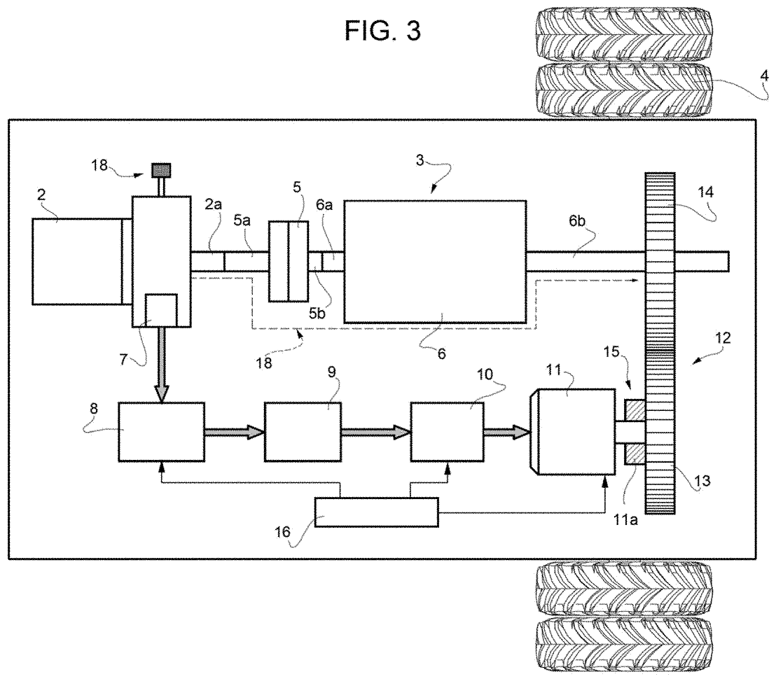

A second operating mode (FIG. 3) wherein the clutch 5 is closed and the manual transmission 6 receives torque from the diesel engine 2 so that the torque is transmitted through a mechanical path 18 to the wheels of the tractor that moves at a speed higher than the speed limit (in the example 18 Km/h); during the second operating mode the clutch 15 is opened and that first power electronics 8 does not power the motor 11 that is inactive.

The control of the engine speed in the first operating mode may be determined by means of a user selectable device, for instance a joystick installed in the cab of the tractor 1.

The advantages are the following:
a) The specialty tractor may be easily driven as a CVT tractor where the PTO angular speed may be kept independent form the tractor's speed; accordingly the driver may stay concentrated on the field operations required by the implement usage and has not to shift the manual transmission and/or to accelerate and decelerate in order to reach the desired PTO angular speed.
b) as consequence of the a) point, the driver can increase the productivity of the tractor in in operations that do not require traction efforts as it is often the case for specialty tractors, as the first operating mode eliminates the need of shifting;
c) the motion of the tractor at low speed according to the first operating mode may be easily controlled as the electric motor 11 enables a simple and comfortable power shuttling and deceleration and motion reversal are achieved by reversing the sense of rotation of the electric motor 11;
d) the same is true for inching operations at very low speed, greatly facilitated by the usage of the electric motor 11 (implement attach);
e) safety is also increased. As the traction is always active at low speed. This is quite important on severe slope, side hill, wherein manual gear shifting creates a gap in traction that can be dangerous.
f) Additional functionality, as zero ground speed holding the tractor stationary on the hill side, can be easily achieved by controlling in torque the electric motor 11 at zero speed;
g) low cost and low maintenance cost. As a low power—low tension electric motor 11 is used the costs are also reduced. The cost of the electric machines is in fact directly related to their size that depends on the generated power.
   The above advantages are obtained without modifying the architecture of an already existing power train 3. Long development times of a new powertrain are not necessary. With the design proposed in the present invention, the impact for R&D cost and for the validation cost, would be much less than for tractor provided with a CVT transmission. In addition to what above stated, the electronic unit 16 is also configured for executing the following operating mode:

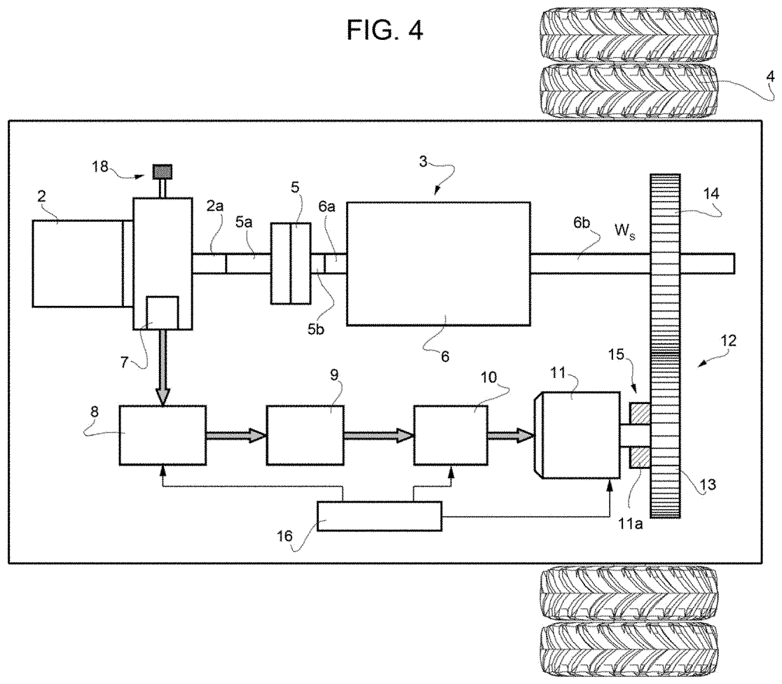

A third operating mode (boost mode, FIG. 4) wherein the clutch 5 is closed and the manual transmission receives torque from the diesel engine 2 so that the output shaft (6-b) of the manual shift transmission rotates at an angular speed ωₛ and torque produced by the engine 2 is transmitted to the wheels 4 of the tractor that moves on the ground.

According to the third operating mode the clutch 15 is closed and the electric motor 11 powered by the energy accumulator 9 is electrically controlled by the second power electronic 10 so that the angular speed of its output shaft 11-a produces, at the output of the power transmission, a speed ωₛ so that the torque produced by the electric motor is added to the torque provided by the engine to provide an extra torque to the wheels.

The third operating mode may be enabled for a short time (some seconds typically) to provide an extra torque (the torque is almost doubled) in particular condition, for instance when the specialty tractor has to overcome an obstacle, for instance an extra slope to climb. The energy necessary to be provided is drawn from the energy accumulator 9 that is rapidly discharged.

1-4. (canceled)

5. A specialty tractor comprising:
wheels;
a diesel engine coupled with a powertrain including a clutch and a manual shift transmission having an output shaft that is configured to transmit power to the, the diesel engine is also coupled with a power take off (PTO) box having a PTO shaft for powering towable implements,
an electric generator configured to receive torque directly from the diesel engine and to provide electric power to an energy accumulator;
power electronics configured to draw up electrical power from the energy accumulator to supply an electric motor whose output shaft configured to be connected/disconnected though a power transmission to the output shaft; and
an electronic unit for controlling power electronics and the power transmission, the electronic unit being configured to perform at least:
a first operating mode in which:
the clutch is opened and the manual transmission does not receive any torque from the diesel engine;
the electric motor supplied by the energy of the accumulator transmits torque to the wheels of the tractor that moves on the ground with a speed lower than a speed limit; and
the diesel engine is controlled with a set rpm that produces a desired angular speed of the PTO shaft making the angular speed of the PTO shaft independent from the speed of the tractor on the ground; and
a second operating mode in which the clutch is closed and the manual transmission receives torque from the diesel engine so that the engine-torque is transmitted to the wheels of the tractor that moves at a speed higher than the speed limit, wherein during the second operating mode the electric motor is unpowered.

6. The specialty tractor of claim 5, wherein the energy accumulator is a battery.

7. The specialty tractor of claim 5, wherein the energy accumulator is a supercapacitor.

8. The specialty tractor of claim 5, further comprising a clutch provided along the power transmission to selectively connect/disconnect the output shaft of the electric motor with the output shaft of the manual shift transmission.

9. The specialty tractor of claim 8, wherein the clutch provided along the power transmission is a dog clutch.

10. The specialty tractor of claim 5, wherein the energy accumulator and electric motor are a low voltage installation.

11. The specialty tractor of claim 10, wherein the electric motor has a power less than or equal to 25 kW and is supplied with a voltage less than or equal to 70 V.

12. The specialty tractor of claim 5, wherein the electronic unit is further configured to perform a third operating mode in which the clutch is closed and the manual transmission receives torque from the diesel engine so that the output shaft of the manual shift transmission rotates at an angular speed and torque produced by the engine is transmitted to the wheels of the tractor that moves on the ground.

13. The specialty tractor of claim 12, further comprising a clutch provided along the power transmission to selectively connect/disconnect the output shaft of the electric motor with the output shaft of the manual shift transmission.

14. The specialty tractor of claim 13, wherein according to the third operating mode a clutch of the power transmission is closed and the electric motor powered by the energy accumulator is electrically controlled so that the angular speed of its output shaft produces, at the output of the power transmission, a speed so that the torque produced by the electric motor is added to the torque provided by the engine to provide an extra torque to the wheels.
